(19) United States
(12) Patent Application Publication
(10) Pub. No.: US 2026/0051090 A1
(43) Pub. Date: Feb. 19, 2026

(54) SYSTEMS, METHODS, AND COMPUTER PROGRAM PRODUCTS FOR VISUALIZING A RELATIONSHIP BETWEEN A PLURALITY OF DATASETS

(71) Applicant: Honeywell International Inc., Charlotte, NC (US)

(72) Inventor: Rishabh Bhatia, Bangalore (IN)

(21) Appl. No.: 18/802,904

(22) Filed: Aug. 13, 2024

(51) Int. Cl. G06T 11/20; G06F 3/04812

(52) U.S. Cl. CPC G06T 11/206; G06F 3/04812

(57) ABSTRACT

Systems, apparatuses, methods, and computer program products are provided herein. For example, a method may include receiving a plurality of datasets. In some embodiments, the method includes identifying a relationship between a first dataset, a second dataset, and a third dataset of the plurality of datasets. In some embodiments, the method includes causing display of a graph depicting the first dataset, the second dataset, and the third dataset via a graphical user interface. In some embodiments, the method includes receiving a user interaction with the graphical user interface indicating a first user-selected datapoint. In some embodiments, the method includes identifying a first datapoint within the first dataset and a second datapoint within the second dataset corresponding to the first user-selected datapoint. In some embodiments, the method includes causing display of an element indicating a relationship between the first datapoint and the second datapoint.

### TECHNOLOGICAL FIELD

Embodiments of the present disclosure relate generally to systems, apparatuses, methods, and computer program products for displaying datasets and relationships between datasets and trend graphs.

### BACKGROUND

Applicant has identified many technical challenges and difficulties associated with systems, methods, and computer program products for displaying data and identifying and displaying relationships between datasets. Through applied effort, ingenuity, and innovation, Applicant has solved problems related to systems, apparatuses, methods, and computer program products for creating a display indicating a relationship between datasets by developing solutions embodied in the present disclosure, which are described in detail below.

### BRIEF SUMMARY

Various embodiments described herein relate to systems, apparatuses, methods, and computer program products for displaying data and identifying and displaying relationships between datasets.

In accordance with one aspect of the disclosure, a method is provided. In some embodiments, the method comprises receiving a first dataset, a second dataset, and a third dataset of a plurality of datasets. In some embodiments, the method includes determining that the third dataset of the plurality of datasets corresponds to a relationship between the first dataset and the second dataset. In some embodiments, the method includes causing display of a graph depicting the first dataset, the second dataset, and the third dataset via a graphical user interface. In some embodiments, the method includes receiving a user interaction with the graphical user interface indicating a first user-selected datapoint within the third dataset. In some embodiments, the method includes identifying a first datapoint within the first dataset corresponding to the first user-selected datapoint within the third dataset and a second datapoint within the second dataset corresponding to the first user user-selected point within the third dataset. In some embodiments, the method includes causing display of an element indicating a relationship between the first datapoint and the second datapoint.

In some embodiments, the method further includes providing a graphical user interface configured to enable user interactions with the displayed graph.

In some embodiments, the data item of the third dataset indicates a delta value between a corresponding data item of the first dataset and a corresponding data item of the second dataset.

In some embodiments, the user interaction corresponds to a placement of a cursor. In some embodiments, the method further includes detecting movement of the cursor from the first user-selected datapoint to a second user-selected datapoint of the third dataset.

In some embodiments, the method further includes identifying a first additional datapoint of the first dataset and a second additional datapoint of the second dataset corresponding to the user-selected datapoint, and displaying an element indicating a relationship between the first additional datapoint and the second additional datapoint.

In some embodiments, the method further includes displaying a text overlay describing the relationship between the first datapoint, the second datapoint, and the first user-selected datapoint.

In some embodiments, displaying an element indicating a relationship between the first datapoint and the second datapoint comprises displaying the element in a first color to indicate a positive delta value from the first datapoint to the second datapoint.

In some embodiments, displaying an element indicating a relationship between the first datapoint and the second datapoint comprises displaying the element in a second color to indicate a negative delta value from the first datapoint to the second datapoint.

In some embodiments, the method further includes defining one or more relationships between a plurality of data types. In some embodiments, the method further includes storing the defined one or more relationships between the plurality of data types in a data library. In some embodiments, the method further includes determining that the third dataset of the plurality of datasets corresponds to a relationship between the first dataset and the second dataset comprises querying the data library to identify the relationship.

In some embodiments, the first dataset corresponds to an operational power dataset, the second dataset corresponds to a design power dataset, and the third dataset corresponds to a design power loss dataset.

In accordance with one aspect of the disclosure, a system is provided. In some embodiments, the system comprises a graphical user interface, memory, and one or more processors communicatively coupled to the memory. In some embodiments, the one or more processors are configured to receive a first dataset, a second dataset, and a third dataset of a plurality of datasets. In some embodiments, the one or more processors are configured to determine that the third dataset of the plurality of datasets corresponds to a relationship between the first dataset and the second dataset. In some embodiments, the one or more processors are configured to cause display of a graph depicting the first dataset, the second dataset, and the third dataset via a graphical user interface. In some embodiments, the one or more processors are configured to receive a user interaction with the graphical user interface indicating a first user-selected datapoint within the third dataset. In some embodiments, the one or more processors are configured to identify a first datapoint within the first dataset corresponding to the first user-selected datapoint within the third dataset and a second datapoint within the second dataset corresponding to the first user user-selected point within the third dataset. In some embodiments, the one or more processors are configured to cause display of an element indicating a relationship between the first datapoint and the second datapoint.

In some embodiments, the one or more processors are configured to detect movement of a cursor from the first user-selected datapoint to a second user-selected datapoint of the third dataset. In some embodiments, the one or more processors are further configured to identify a first additional datapoint of the first dataset and a second additional datapoint of the second dataset corresponding to the user-selected datapoint. In some embodiments, the one or more processors are further configured to cause display of an element indicating a relationship between the first additional datapoint and the second additional datapoint.

In some embodiments, the one or more processors are configured to define one or more relationships between a plurality of data types. In some embodiments, the one or more processors are further configured to store the defined one or more relationships between the plurality of data types in a data library. In some embodiments, the one or more processors are further configured to query the data library to identify the relationship between the first dataset and the second dataset.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for receiving a first dataset, a second dataset, and a third dataset of the plurality of datasets. In some embodiments, the computer program code, in execution with at least one processor, configures the computer program product for determining that the third dataset of the plurality of datasets corresponds to a relationship between the first dataset and the second dataset. In some embodiments, the computer program code, in execution with at least one processor, configures the computer program product for causing display of a graph depicting the first dataset, the second dataset, and the third dataset via a graphical user interface. In some embodiments, the computer program code, in execution with at least one processor, configures the computer program product for receiving a user interaction with the graphical user interface indicating a first user-selected datapoint within the third dataset. In some embodiments, the computer program code, in execution with at least one processor, configures the computer program product for identifying a first datapoint within the first dataset corresponding to the first user-selected datapoint within the third dataset and a second datapoint within the second dataset corresponding to the first user-selected point within the third dataset. In some embodiments, the computer program code, in execution with at least one processor, configures the computer program product for causing display of an element indicating a relationship between the first datapoint and the second datapoint.

In some embodiments, the computer program code, in execution with at least one processor, configures the computer program product for detecting movement of a cursor from the first user-selected datapoint to a second user-selected datapoint of the third dataset. In some embodiments, the computer program code, in execution with at least one processor, configures the computer program product for identifying a first additional datapoint of the first dataset and a second additional datapoint of the second dataset corresponding to the user-selected datapoint. In some embodiments, the computer program code, in execution with at least one processor, configures the computer program product for causing display of an element indicating a relationship between the first additional datapoint and the second additional datapoint.

In some embodiments, the computer program code, in execution with at least one processor, configures the computer program product for defining one or more relationships between a plurality of data types. In some embodiments, the computer program code, in execution with at least one processor, configures the computer program product for storing the defined one or more relationships between the plurality of data types in a data library. In some embodiments, the computer program code, in execution with at least one processor, configures the computer program product for querying the data library to identify the relationship between the first dataset and the second dataset.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of an example apparatus that may be specially configured in accordance with an example embodiment of the present disclosure;

FIG. 3 illustrates a flowchart of an example method in accordance with one or more embodiments of the present disclosure;

FIG. 4 illustrates a flowchart of an example method in accordance with one or more embodiments of the present disclosure;

FIG. 5 illustrates a flowchart of an example method in accordance with one or more embodiments of the present disclosure;

FIG. 6 illustrates an example interface in accordance with one or more embodiments of the present disclosure; and

FIG. 7 depicts an example interface in accordance with at least one embodiment of the present invention.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with displaying data and identifying and visualizing relationships between datasets. As would be understood by one skilled in the field to which this disclosure pertains, there are numerous example scenarios in which it may be desirable to visualize relationships between datasets.

In many applications, systems, methods, and computer program products for intuitively displaying relationships between datasets are desirable. In some implementations, it may be desirable to visualize relationships between datasets using a system comprising a graphical user interface, memory, and one or more processors communicatively coupled to the memory. For example, it may be desirable to display relationships between a first dataset, a second dataset, and a third dataset (“three datasets”), such that a user of the system can intuitively understand a relationship between the three datasets without requiring training or background knowledge.

Thus, to address these and/or other issues related to such example solutions, example systems, apparatuses, methods, and computer program products for intuitively displaying relationships between datasets are disclosed herein. For example, an embodiment, in this disclosure, described in greater detail below, includes a system that includes a computing device. In some embodiments, the computing device is configured to receive a plurality of datasets. In some embodiments, the computing device is configured to identify a relationship between a first dataset, a second dataset, and a third dataset of the plurality of datasets. In some embodiments, the computing device is configured to cause display of a graph depicting the first dataset, the second dataset, and the third dataset via a graphical user interface. In some embodiments, the computing device is configured to receive a user interaction with the graphical user interface indicating a first user-selected datapoint within the third dataset. In some embodiments, the computing device is configured to identify a first datapoint within the first dataset and a second datapoint within the second dataset corresponding to the first user-selected datapoint. In some embodiments, the computing device is configured to cause display of an element indicating a relationship between the first datapoint and the second datapoint. Accordingly, the systems, apparatuses, methods, and computer program products disclosed herein enable intuitive data relationship display.

### Example Systems and Apparatuses

Embodiments of the present disclosure herein include systems, methods, and computer program products configured for visualizing relationships between a plurality of datasets. It should be readily appreciated that the embodiments of the apparatus, systems, methods, and computer program product described herein may be configured in various additional and alternative manners in addition to those expressly described herein.

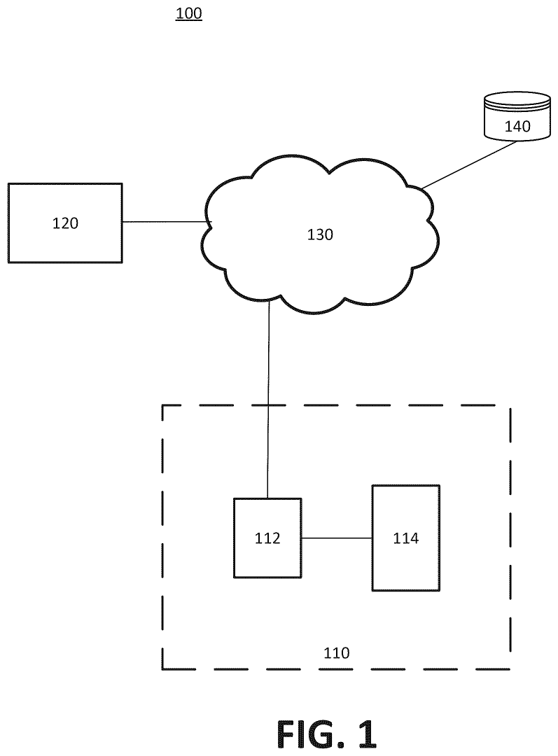

FIG. 1 illustrates an example block diagram of an environment 100 in which embodiments of the present disclosure may operate. As depicted, FIG. 1 includes a computing device 110, one or more data sources 120, a network 130, and one or more databases 140. Environment 100 corresponds to an environment in which the methods as described herein may be executed.

In some embodiments, the environment 100 includes a computing device 110. The computing device 110 may be located remotely from one or more data sources 120 and the one or more databases 140. In this regard, for example, the computing device 110 may be located in a remote cloud server, for example, and electronically and/or communicatively coupled to any of the one or more data sources 120 and the one or more databases 140 via at least the network 130. In some embodiments, the computing device 110 is configured via hardware, software, firmware, and/or a combination thereof to perform data intake of one or more types of data, such as data received from the one or more data sources 120 and/or the one or more databases 140. In at least some embodiments, the computing device 110 is configured to receive operational power data, design power data, and design power loss data from the one or more data sources 120.

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

As depicted, in some embodiments, computing device 110 includes application 112 and graphical user interface (GUI) 114. In some embodiments, the application 112 is configured to generate and/or transmit command(s) that control, adjust, or otherwise impact operations of the one or more data sources 120 and the one or more databases 140. For example, the application 112 may be configured to send instructions to one or more databases 140 to create a data library by storing one or more determined relationships between one or more data types. For example, in various embodiments, the computing device 110 and the application 112 may be configured to execute and/or perform one or more operations and/or functions described herein.

In some embodiments, the computing device 110 is configured to receive a plurality of datasets. In some embodiments, the computing device 110 is configured to identify a relationship between a first dataset, a second dataset, and a third dataset of the plurality of datasets. In some embodiments, the computing device 110 is configured to cause display of a graph depicting the first dataset, the second dataset, and the third dataset via a graphical user interface. In some embodiments, the computing device 110 is configured to receive a user interaction with the graphical user interface indicating a first user-selected datapoint within the third dataset. In some embodiments, the computing device 110 is configured to identify a first datapoint within the first dataset and a second datapoint within the second dataset corresponding to the first user-selected datapoint. In at least some embodiments, the computing device 110 is configured to cause display of an element indicating a relationship between the first datapoint and the second datapoint.

In some embodiments, the computing device 110 is configured to detect movement of a cursor from a first user-selected datapoint to a second user-selected datapoint of a third dataset. In some embodiments, the computing device 110 is configured to identify a first additional datapoint of a first dataset and a second additional datapoint of the second dataset corresponding to the second user-selected datapoint. In some embodiments, the computing device 110 is configured to cause display of an element indicating a relationship between the first additional datapoint and the second additional datapoint.

In some embodiments, the computing device 110 is configured to define one or more relationships between two or more datasets of a plurality of datasets. In some embodiments, the computing device 110 is configured to store the defined one or more relationships between datasets of the plurality of datasets in a data library. In some embodiments, the one or more databases 140 are configured to store the data library. In some embodiments, the computing device 110 is configured to receive a request to determine a relationship between a first dataset, a second dataset, and a third dataset. In some embodiments, the computing device 110 is configured to query the data library to identify a defined relationship between the first dataset, the second dataset, and the third dataset. In some embodiments, the computing device 110 is configured to provide the identified relationship between the first dataset, the second dataset, and the third dataset.

The one or more data sources 120 may be configured to provide a plurality of datasets for display by computing device 110 via application 112 and graphical user interface 114. It should be appreciated that, while the one or more data sources 120 are depicted as separate from computing device 110 in the depicted embodiment of environment 100, the computing device 110 may include in additional embodiments.

The one or more databases 140 may be configured to receive, store, and/or transmit data. For example, the one or more databases 140 may be configured to receive, store, and/or transmit data associated with the computing device 110 and/or the one or more data sources 120. In this regard, for example, the one or more databases 140 may be configured to receive, store, and/or transmit. The one or more databases 140 may be located remotely from computing device 110, in proximity of the computing device 110, and/or within the computing device 110. In some embodiments, the one or more databases 140 may be representative and/or indicative of an data relation database.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the computing device 110 may include the one or more databases 140.

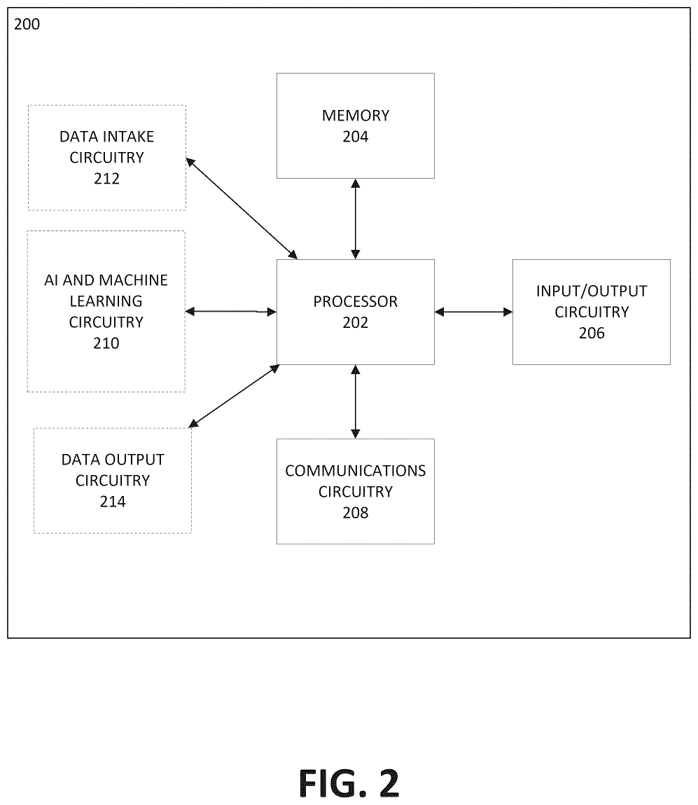

FIG. 2 illustrates an example block diagram of an example system that may be specially configured in accordance with an example embodiment of the present disclosure. Specifically, FIG. 2 depicts an example computing apparatus 200 (“apparatus 200”) specially configured in accordance with at least some example embodiments of the present disclosure. For example, the computing apparatus 200 may be embodied as one or more of a specifically configured personal computing apparatus, a specifically configured cloud-based computing apparatus, a specifically configured embedded computing device (e.g., configured for edge computing, and/or the like). Examples of an apparatus 200 may include, but is not limited to, computing device 110, the one or more databases 140, and/or the one or more data sources 120. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, computing apparatus 200 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuitry 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally, or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data from the one or more data sources 120. In some embodiments, the data intake circuitry 212 includes hardware, software, firmware, and/or a combination thereof, that retrieves particular data associated with the one or more data sources 120 from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model. In at least some embodiments, AI and machine learning circuitry 210 may be configured to analyze known relationships between historical datasets, and determine relationships between a current plurality of datasets based on the machine learning model and/or AI analysis. In general, the AI and machine learning circuitry 210 may be configured to classify the datasets and corresponding relationships between datasets.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally, or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect to the AI and machine learning circuitry 210.

### Example Methods

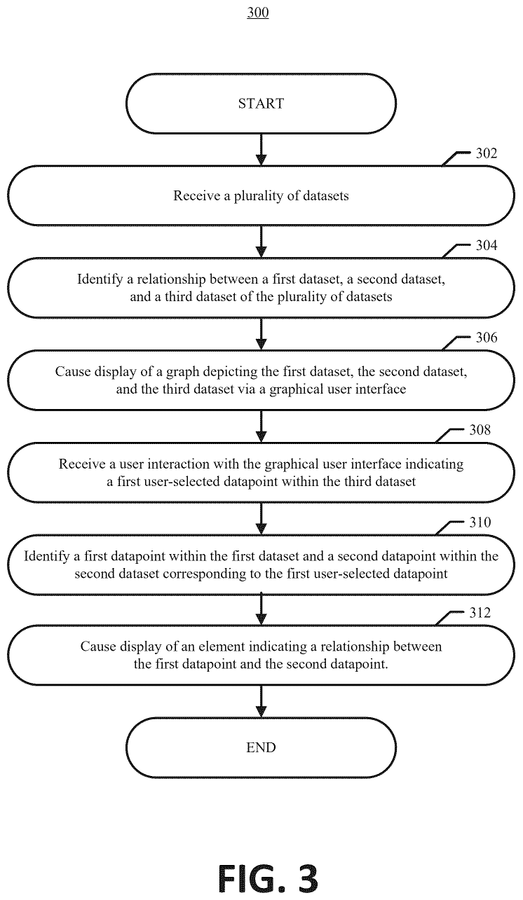

Referring now to FIG. 3, a flowchart providing an example method 300 is illustrated. In this regard, FIG. 3 illustrates operations that may be performed by the computing device 110, the one or more data sources 120, the one or more databases 140, and/or the like. In some embodiments, the example method 300 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 300.

As shown in block 302, the method 300 may include receiving a plurality of datasets. As described above, in some embodiments, the computing device 110 is configured to receive one or more datasets from one or more data sources, such as the one or more data sources 120. In some embodiments, the received plurality of datasets includes one or more datasets directed towards trend data. In some embodiments, the computing device 110 is configured to receive the plurality of datasets in the form of a trend graph displaying the plurality of datasets. The trend graph may display each dataset of the plurality of datasets as a trend line. In at least some embodiments, the x-axis of the trend graph corresponds to a time-based variable.

As shown in block 304, the method 300 may include identifying a relationship between a first dataset, a second dataset, and a third dataset of the plurality of datasets. In some embodiments, the computing device 110 is configured to determine that a third dataset of the plurality of datasets corresponds to the difference between two additional datasets of the plurality of datasets. In some embodiments, the computing device 110 is configured to algorithmically analyze the received plurality of datasets to determine whether any of the received datasets correspond to arithmetic functions of one another. In other words, computing device 110 may be configured to determine whether a received dataset corresponds to, for example, a combination of two other received datasets. In some embodiments, computing device 110 is configured to query a dataset relationship library to identify a relationship between the first dataset, the second dataset, and the third dataset of the plurality of datasets. In some embodiments, the computing device 110 is configured to determine that datapoints of the third dataset correspond to a delta value between the corresponding points of the first dataset and the second dataset. “Corresponding points” of the various datasets, as used herein, may refer to datapoints from the various datasets which occur at the same value along the x-axis. In some embodiments, corresponding points are points which are recorded/reported at a same time value.

As shown in block 306, the method 300 may include causing display of a graph depicting the first dataset, the second dataset, and the third dataset via a graphical user interface. In some embodiments, such as those where the plurality of datasets is not received in graph format, the computing device 110 is configured to generate a trend graph displaying at least the first dataset, the second dataset, and the third dataset. In some embodiments, the computing device 110 is configured to display, via an operably connected graphical user interface, a trend graph displaying the first dataset, the second dataset, and the third dataset. In yet other embodiments, the computing device 110 is configured to issue instructions to an additional device causing said additional device to display a trend graph displaying the first dataset, the second dataset, and the third dataset. In some embodiments, the computing device 110 is configured to generate and display a first trend line corresponding to the first dataset, a second trend line corresponding to the second dataset, and a third trend line corresponding to the third dataset.

As shown in block 308, the method 300 may include receiving a user interaction with the graphical user interface indicating a first user-selected datapoint within the third dataset. In some embodiments, the computing device 110 is configured to detect a cursor's position with respect to the graphical user interface. In such embodiments, the computing device 110 is configured to identify a datapoint within the third dataset that is closest to the cursor's position. In some embodiments, the computing device 110 is configured to detect a user's interaction with a touchscreen element corresponding to the graphical user interface. In such embodiments, the computing device 110 is configured to identify a datapoint within the third dataset that is closest to the position of the user's interaction with the touchscreen element. In some embodiments, the computing device 110 is configured to identify a user selected datapoint corresponding to an explicit datapoint of the third dataset. In other embodiments, the computing device 110 is configured to identify a user selected datapoint closest to the user's interaction with the graphical user interface such that the user selected datapoint corresponds to any point along the third trend line corresponding to the third dataset (i.e., the user may select a point along the third trend line between two datapoints of the third dataset). In such embodiments, the computing device 110 is configured to determine a set of X and Y coordinates corresponding to the user selected datapoint along the third trend line. In some embodiments, a user's interaction with the graphical user interface may correspond to a user positioning a cursor in a particular position with respect to the third dataset, with or without utilizing a click or other selection feature. In other words, the user interaction may correspond to a user moving a cursor to “hover” over a point.

As shown in block 310, the method 300 may include identifying a first datapoint within the first dataset and a second datapoint within the second dataset corresponding to the first user-selected datapoint. In at least some embodiments, the computing device 110 is configured to identify an x-axis value or a time value corresponding to the first user-selected datapoint. In such embodiments, the computing device 110 is configured to identify a first datapoint within the first dataset occurring at the identified x-axis value or time value. Similarly, in such embodiments, the computing device 110 is configured to identify a second datapoint within the second dataset occurring at the identified x-axis value or time value.

As shown in block 312, the method 300 may include causing display of an element indicating a relationship between the first datapoint and the second datapoint. In some embodiments, the computing device 110 is configured to generate and display a vertical line element between the first datapoint and the second datapoint, wherein the vertical line element corresponds to the delta value between the first datapoint and the second datapoint as defined by the user selected datapoint of the third dataset. In some embodiments, the computing device 110 is configured to generate and display an element between the first datapoint and the second datapoint according to a first set of display characteristics. The first set of display characteristics may define a color, pattern, shade, fill, or other display characteristic(s) for the generated element. In some embodiments, the computing device 110 is configured to generate and display the element according to the first set of display characteristics when the element corresponds to a positive delta value between the first datapoint and the second datapoint (i.e., a positive value of the user-selected datapoint). In some embodiments, the computing device 110 is configured to generate and display an element between the first datapoint and the second datapoint according to a second set of display characteristics. The second set of display characteristics may define a color, pattern, shade, fill, or other display characteristic(s) for the generated element. In some embodiments, the computing device 110 is configured to generate and display the element according to the second set of display characteristics when the element corresponds to a negative delta value between the first datapoint and the second datapoint (i.e., a negative value of the user-selected datapoint). In some embodiments, the computing device 110 is configured to generate an element with a height equivalent to the Y-axis value corresponding to the first user-selected datapoint and display said element between the first datapoint and the second datapoint. In some embodiments, the computing device 110 is configured to generate an element in a color indicated by a severity spectrum. For example, the computing device 110 may be configured to generate an element that is yellow if the delta value between the first datapoint and the second datapoint falls within a first range. In the same example, the computing device 110 may be configured to generate an element that is orange if the delta value between the first datapoint and the second data point falls within a second range comprising larger values than the first range. In the same example, the computing device 110 may be configured to generate an element that is red if the delta value between the first datapoint and the second datapoint falls within a third range comprising larger values than the second range. Such ranges and colors may be defined differently with respect to positive delta values and negative delta values.

In at least some embodiments, such as embodiments wherein the trend graph depicts one or more additional datasets beyond the subject first dataset, second dataset, and third dataset, the computing device 110 is configured to update the trend graph responsive to the user interaction such that the trend lines corresponding to the subject first dataset, second dataset, and third dataset are displayed with different visual characteristics than the one or more additional datasets. For example, the computing device 110 may be configured to display the trend lines corresponding to the subject first dataset, second dataset, and third dataset in a first color, while the trend lines corresponding to the one or more additional datasets are displayed in a second color. The computing device 110 may be configured to display the trend graph such that the one or more additional datasets are grayed out, such that the trend lines corresponding to the subject first dataset, second dataset, and third dataset are more visually prominent in the display. In general, the computing device 110 may be configured to configure display settings such that the subject first dataset, second dataset, and third dataset are displayed with characteristics that are visually distinct from the depiction of the one or more additional datasets.

In some embodiments, the method 300 additionally includes detecting a second user interaction causing movement of a cursor from the first user-selected datapoint to a second user-selected datapoint of the third dataset. In such embodiments, the computing device 110 may additionally be configured to identify a first additional datapoint of the first dataset and a second additional datapoint of the second dataset corresponding to the second user-selected datapoint. In such embodiments, the computing device 110 may be configured to display a second element indicating a relationship between the first additional datapoint and the second additional datapoint as indicated by the second user-selected datapoint of the third dataset. In some embodiments, the computing device 110 is configured to cease displaying the initially generated element between the first datapoint and the second datapoint corresponding to the first user-selected datapoint upon generating the second element. In some embodiments, the computing device 110 is configured to generate the second element by altering the features of the initially generated element such that it reflects the appropriate characteristics of the relationship between the first additional datapoint and the second additional datapoint. Altering the features of the initially generated element may include, but is not limited to, any of adjusting the element's X and Y coordinates relative to the trend graph, adjusting the position of the endpoints of the element, adjusting any display characteristics of the element (including, but not limited to, pattern, color, shade, fill, and the like), and/or adjusting the height of the element. In at least some embodiments, as a user repositions their cursor repeatedly along the third trend line/third dataset, the computing device 110 may be configured to dynamically adjust the features of the initially generated element to reflect each datapoint of the third dataset encompassed by the cursor's movement.

In at least some embodiments, the method 300 additionally includes displaying a text overlay via the graphical user interface indicating the relationship between the first dataset, the second dataset, and the third dataset. For example, in an embodiment wherein the third dataset “C” is equivalent to the first dataset “A” subtracted from the second dataset “B”, the computing device 110 may be configured to display a text element indicating that “C=B−A”, such that the user can readily identify both the magnitude of the relationship as depicted by the generated element as well as the process by which the element is determined. In some embodiments, the computing device 110 is configured to display the text overlay within the display trend graph. In some embodiments, the computing device 110 is configured to display a selectable element corresponding to the text overlay, such that the text overlay itself is not displayed until a user interacts with said selectable element.

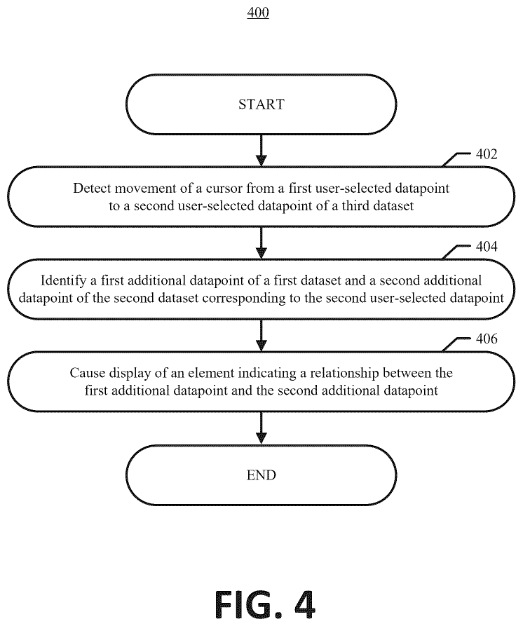

Referring now to FIG. 4, a flowchart providing an example method 400 is illustrated. In this regard, FIG. 4 illustrates operations that may be performed by the computing device 110, the one or more data sources 120, the one or more databases 140, and/or the like. In some embodiments, the example method 400 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 400.

As shown in block 402, the method 400 may include detecting movement of a cursor from a first user-selected datapoint to a second user-selected datapoint of a third dataset. In some embodiments, the computing device 110 is configured to monitor a user's manipulation of a cursor element. The cursor element, as used herein, may be, but is not limited to, to a mouse cursor, a point of interaction with a touch screen interface, a gaze-based controller configured to move a cursor according to a user's detected gaze, or any other element via which a user can select or otherwise interact with elements of a display/graphical user interface. In some embodiments, the computing device 110 is configured to detect that the user has selected a second user-selected datapoint of a third dataset. In some embodiments, the computing device 110 is configured to identify coordinates corresponding to the second user-selected datapoint.

As shown in block 404, the method 400 may include identifying a first additional datapoint of the first dataset and a second additional datapoint of the second dataset corresponding to the second user-selected datapoint. In some embodiments, the computing device 110 is configured to identify an x-axis value or a time value corresponding to the second user-selected datapoint. In such embodiments, the computing device 110 is configured to identify a first additional datapoint within the first dataset occurring at the identified x-axis value or time value. Similarly, in such embodiments, the computing device 110 is configured to identify a second additional datapoint within the second dataset occurring at the identified x-axis value or time value.

As shown in block 406, the method 400 may include causing display of an element indicating a relationship between the first additional datapoint and the second additional datapoint. In some embodiments, the computing device 110 is configured to generate and display a vertical line element between the first additional datapoint and the second additional datapoint, wherein the vertical line element corresponds to the delta value between the first additional datapoint and the second additional datapoint as defined by the second user-selected datapoint of the third dataset. In some embodiments, the computing device 110 is configured to generate and display an element between the first additional datapoint and the second additional datapoint according to a first set of display characteristics. The first set of display characteristics may define a color, pattern, shade, fill, or other display characteristic(s) for the generated element. In some embodiments, the computing device 110 is configured to generate and display the element according to the first set of display characteristics when the element corresponds to a positive delta value between the first additional datapoint and the second additional datapoint (i.e., a positive value of the second user-selected datapoint). In some embodiments, the computing device 110 is configured to generate and display an element between the first additional datapoint and the second additional datapoint according to a second set of display characteristics. The second set of display characteristics may define a color, pattern, shade, fill, or other display characteristic(s) for the generated element. In some embodiments, the computing device 110 is configured to generate and display the element according to the second set of display characteristics when the element corresponds to a negative delta value between the first additional datapoint and the additional second datapoint (i.e., a negative value of the second user-selected datapoint). In some embodiments, the computing device 110 is configured to generate an element with a height equivalent to the Y-axis value corresponding to the second user-selected datapoint and display said element between the first additional datapoint and the second additional datapoint.

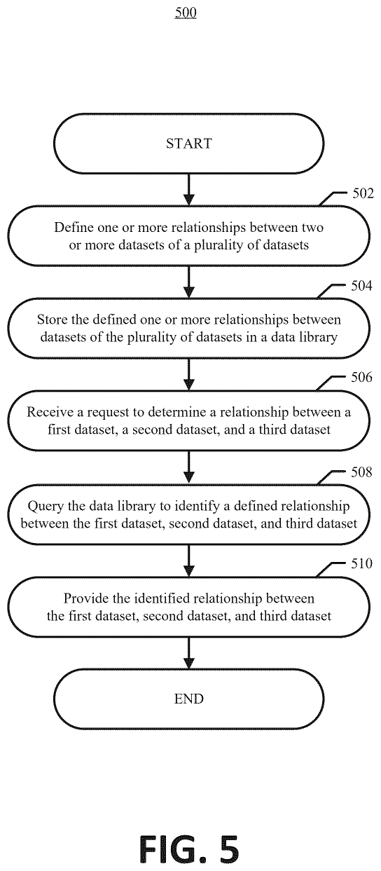

Referring now to FIG. 5, a flowchart providing an example method 500 is illustrated. In this regard, FIG. 5 illustrates operations that may be performed by the computing device 110, the one or more data sources 120, the one or more databases 140, and/or the like. In some embodiments, the example method 500 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 500.

As shown in block 502, the method 500 may include defining one or more relationships between two or more datasets of a plurality of datasets. In some embodiments, the computing device 110 is configured to programmatically analyze and compare the plurality of datasets to determine whether any of the datasets are arithmetically related. For example, the computing device 110 may be configured to determine whether any datasets of the plurality of datasets correspond to a combination of additional datasets of the plurality of datasets. In some embodiments, the computing device 110 is configured to prompt one or more subject matter experts to define one or more relationships between two or more datasets of a plurality of datasets. For example, the computing device 110 may provide the plurality of datasets to one or more reviewers. The computing device 110 may further be configured to receive review results identifying one or more relationships corresponding to the plurality of datasets. In some embodiments, the computing device 110 is configured to identify variables corresponding to the plurality of datasets, and conduct a search to identify one or more relationships between said variables. In such embodiments, the computing device 110 is configured to store a record in a data library indicating the defined one or more relationships. The computing device 110 may be configured to define the relationships according to variable names corresponding to the subject datasets. In at least some embodiments, the computing device 110 is configured to define the relationships according to the names of the subject datasets. In at least some embodiments, the computing device 110 is configured to define the relationships according to the data types of the subject datasets. In at least some embodiments, the computing device 110 is configured to apply one or more machine learning models to the received plurality of datasets to identify one or more relationships between the received plurality of datasets. In at least some embodiments, the one or more machine learning models are configured to compare the received plurality of datasets to a set of datasets amongst whom one or more relationships are defined. In other words, the one or more machine learning models may be configured to compare the features of the received plurality of datasets to the features of two or more datasets between whom a relationship is defined, such that an appropriate relationship may be determined based on how closely said features match.

As shown in block 504, the method 500 may include storing the defined one or more relationships between datasets of the plurality of datasets in a data library. In some embodiments, the data library includes one or more records, wherein each record indicates a relationship between two or more datasets. In some embodiments, the one or more records of the data library each indicate a relationship between two or more variables. In general, storing the defined one or more relationships between datasets of the plurality of datasets in a data library may include any methodology for storing relationship information for the plurality of datasets in a format that is searchable/able to be queried. In some embodiments, the computing device 110 is configured to store the defined one or more relationships between datasets in a data library stored in the one or more databases 140.

As shown in block 506, the method 500 may include receiving a request to determine a relationship between a first dataset, a second dataset, and a third dataset. In some embodiments, the computing device 110 is configured to receive a request to display a relationship between the first dataset, the second dataset, and the third dataset. In such embodiments, the computing device 110 is configured first identify any relationship corresponding to the first dataset, the second dataset, and the third dataset. In some embodiments, receiving a request to determine a relationship between a first dataset, a second dataset, and a third dataset includes receiving a request to determine a relationship between a first variable corresponding to the first dataset, a second variable corresponding to the second dataset, and a third variable corresponding to the third dataset.

As shown in block 508, the method 500 may include querying the data library to identify a defined relationship between the first dataset, the second dataset, and the third dataset. In some embodiments, the computing device 110 is configured to query the data library for any defined relationships corresponding to the first dataset, the second dataset, and the third dataset. In some embodiments, the computing device 110 is configured to query the one or more databases 140 for a defined relationship corresponding to the variables of the first dataset, the second dataset, and the third dataset. In at least some embodiments, the computing device 110 is configured to search the one or more databases 140 for entries corresponding to datasets of the same types as the first dataset, the second dataset, and the third dataset.

As shown in block 510, the method 500 may include providing the identified relationship between the first dataset, the second dataset, and the third dataset. In at least some embodiments, the one or more databases 140 are configured to provide the identified relationship to the computing device 110. In general, the databases 140 may be configured to make the identified relationship available such that computing device 110 may apply it to the first dataset, the second dataset, and the third dataset.

In at least some embodiments, the methods as disclosed herein (i.e., method 300, method 400, method 500) are executed with respect to the energy management domain. For example, in some embodiments, the first dataset as described above may correspond to an operating power dataset, the second dataset as described above may correspond to a design power dataset, and the third dataset as described above may correspond to a design power loss dataset. Thus, identifying the relationship with respect to these three datasets includes determining that, for the design power loss dataset “DPL”, the design power dataset “DP”, and the operating power dataset OP, DPL=OP−DP.

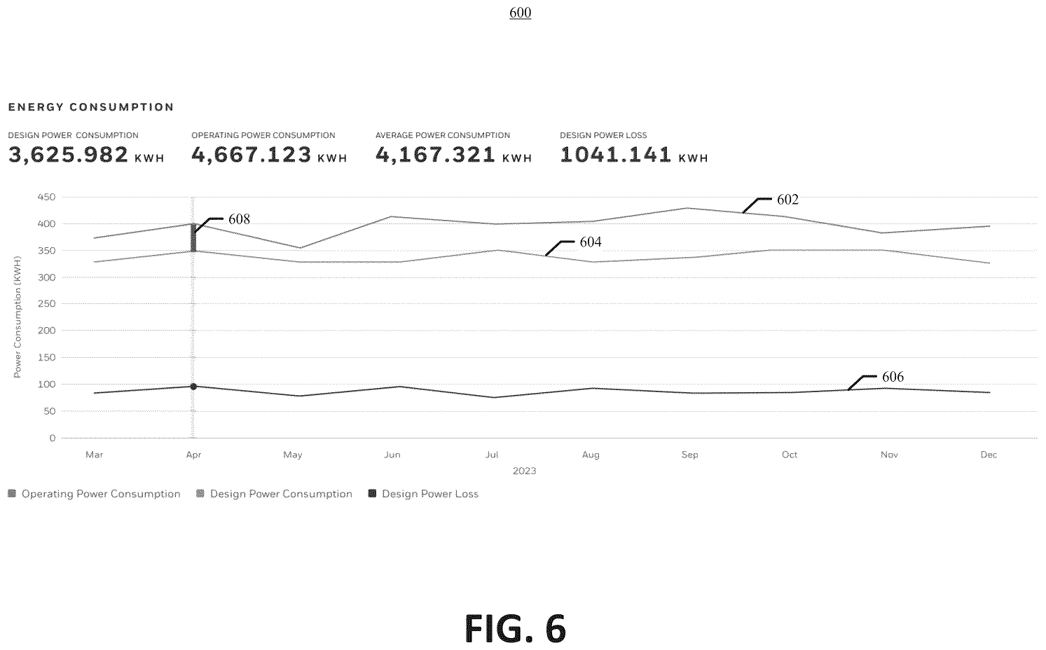

FIG. 6 depicts an example interface 600 in accordance with at least one embodiment of the present invention. As depicted, the example interface 600 displays power consumption in kilowatt hours (KWH) on the Y-axis, time (in months) on the X-axis, and trend lines corresponding to three datasets. As depicted, the example interface 600 includes a first trend line 602 corresponding to an operating power consumption dataset, a second trend line 604 corresponding to a design power consumption dataset, and a third trend line 606 corresponding to a design power loss dataset. The example interface 600 further includes a generated element 608, which depicts the difference between the first trend line 602 and the second trend line 604 at the user selected point on the third trend line 606 corresponding to the data corresponding to the April x-axis value. Each trend graph line may be depicted in a different color or pattern indicated by a key. With respect to the example embodiment, the generated element 608 may be depicted in red, for example, to depict a negative value between design power consumption and operating power consumption. The design power loss value may also be depicted in red, for example, to identify the correlation between the generated element and the design power loss value.

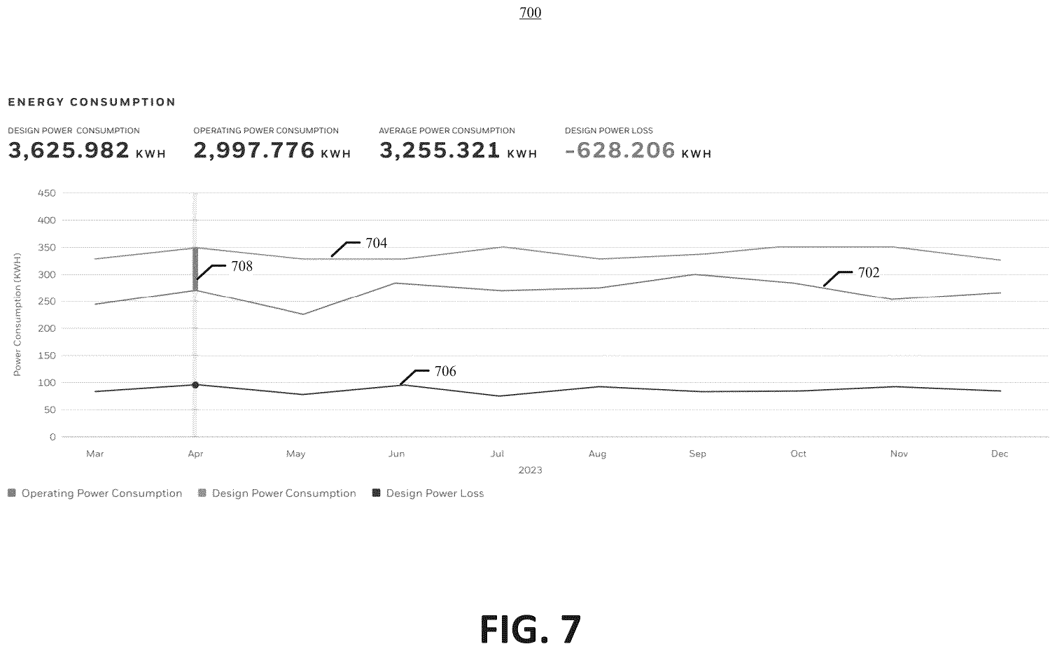

FIG. 7 depicts an example interface 700 in accordance with at least one embodiment of the present invention. As depicted, the example interface 700 displays power consumption in kilowatt hours (KWH) on the Y-axis, time (in months) on the X-axis, and trend lines corresponding to three datasets. As depicted, the example interface 700 includes a first trend line 702 corresponding to an operating power consumption dataset, a second trend line 704 corresponding to a design power consumption dataset, and a third trend line 706 corresponding to a design power loss dataset. The example interface 600 further includes a generated element 708, which depicts the difference between the first trend line 702 and the second trend line 704 at the user selected point on the third trend line 706 corresponding to the data corresponding to the April x-axis value. Each trend graph line may be depicted in a different color or pattern indicated by a key. With respect to the example embodiment, the generated element 708 may be depicted in green, for example, to depict a positive value between design power consumption and operating power consumption. The design power loss value may also be depicted in green, for example, to identify the correlation between the generated element and the design power loss value.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

1. A method comprising:
receiving, by one or more processors, a first dataset, a second dataset, and a third dataset of a plurality of datasets;
determining, by the one or more processors, that the third dataset of the plurality of datasets corresponds to a relationship between the first dataset and the second dataset;
causing, by the one or more processors, display of a graph depicting the first dataset, the second dataset, and the third dataset via a graphical user interface;
receiving, by the one or more processors, a user interaction with the graphical user interface indicating a first user-selected datapoint within the third dataset;
identifying, by the one or more processors, a first datapoint within the first dataset corresponding to the first user-selected datapoint within the third dataset and a second datapoint within the second dataset corresponding to the first user-selected point within the third dataset; and
causing, by the one or more processors, display of an element indicating a relationship between the first datapoint and the second datapoint.

2. The method of claim 1, further comprising providing, by the one or more processors, a graphical user interface configured to enable user interactions with the displayed graph.

3. The method of claim 1, wherein a data item of the third dataset indicates a delta value between a corresponding data item of the first dataset and a corresponding data item of the second dataset.

4. The method of claim 1, wherein the user interaction corresponds to a placement of a cursor.

5. The method of claim 4, further comprising detecting, by the one or more processors, movement of the cursor from the first user-selected datapoint to a second user-selected datapoint of the third dataset.

6. The method of claim 5, further comprising:
identifying, by the one or more processors, a first additional datapoint of the first dataset and a second additional datapoint of the second dataset corresponding to the second user-selected datapoint; and
displaying, by the one or more processors, an element indicating a relationship between the first additional datapoint and the second additional datapoint.

7. The method of claim 1, further comprising displaying, by the one or more processors, a text overlay describing the relationship between the first datapoint, the second datapoint, and the third datapoint.

8. The method of claim 3, wherein displaying an element indicating a relationship between the first datapoint and the second datapoint comprises displaying the element in a first color to indicate a positive delta value from the first datapoint to the second datapoint.

9. The method of claim 3, wherein displaying an element indicating a relationship between the first datapoint and the second datapoint comprises displaying the element in a second color to indicate a negative delta value from the first datapoint to the second datapoint.

10. The method of claim 1, further comprising defining, by the one or more processors, one or more relationships between a plurality of data types.

11. The method of claim 10, further comprising storing, by the one or more processors, the defined one or more relationships between the plurality of data types in a data library.

12. The method of claim 11, wherein determining that the third dataset of the plurality of datasets corresponds to a relationship between the first dataset and the second dataset comprises querying the data library to identify the relationship.

13. The method of claim 1, wherein the first dataset corresponds to an operational power dataset, the second set corresponds to a design power dataset, and the third dataset corresponds to a design power loss dataset.

14. A system comprising:
a graphical user interface; and
memory and one or more processors communicatively coupled to the memory, the one or more processors configured to:
receive a first dataset, a second dataset, and a third dataset of a plurality of datasets;
determine that the third dataset of the plurality of datasets corresponds to a relationship between the first dataset and the second dataset;
cause display of a graph depicting the first dataset, the second dataset, and the third dataset via a graphical user interface;
receive a user interaction with the graphical user interface indicating a first user-selected datapoint within the third dataset;
identify a first datapoint within the first dataset corresponding to the first user-selected datapoint within the third dataset and a second datapoint within the second dataset corresponding to the first user-selected point within the third dataset; and
cause display of an element indicating a relationship between the first datapoint and the second datapoint.

15. The system of claim 14, the one or more processors further configured to:
detect movement of a cursor from the first user-selected datapoint to a second user-selected datapoint of the third dataset;
identify a first additional datapoint of the first dataset and a second additional datapoint of the second dataset corresponding to the second user-selected datapoint; and
cause display of an element indicating a relationship between the first additional datapoint and the second additional datapoint.

16. The system of claim 14, the one or more processors further configured to:
define one or more relationships between a plurality of data types;
store the defined one or more relationships between the plurality of data types in a data library; and
query the data library to identify the relationship between the first dataset and the second dataset.

17. The system of claim 14, wherein a data item of the third dataset indicates a delta value between a corresponding data item of the first dataset and a corresponding data item of the second dataset.

18. A computer program product comprising at least one non-transitory computer-readable storage medium having computer program code stored thereon that, in execution with at least one processor, configures the computer program product for:
receiving a first dataset, a second dataset, and a third dataset of a plurality of datasets;
determining that the third dataset of the plurality of datasets corresponds to a relationship between the first dataset and the second dataset;
causing display of a graph depicting the first dataset, the second dataset, and the third dataset via a graphical user interface;
receiving a user interaction with the graphical user interface indicating a first user-selected datapoint within the third dataset;
identifying a first datapoint within the first dataset corresponding to the first user-selected datapoint within the third dataset and a second datapoint within the second dataset corresponding to the first user-selected point within the third dataset; and
causing display of an element indicating a relationship between the first datapoint and the second datapoint.

19. The computer program product of claim 18, the at least one non-transitory computer-readable storage medium having computer program code stored thereon that, in execution with at least one processor, further configures the computer program product for:
detecting movement of a cursor from the first user-selected datapoint to a second user-selected datapoint of the third dataset;
identifying a first additional datapoint of the first dataset and a second additional datapoint of the second dataset corresponding to the second user-selected datapoint; and
causing display of an element indicating a relationship between the first additional datapoint and the second additional datapoint.

20. The computer program product of claim 18, the at least one non-transitory computer-readable storage medium having computer program code stored thereon that, in execution with at least one processor, further configures the computer program product for:
defining one or more relationships between a plurality of data types;
storing the defined one or more relationships between the plurality of data types in a data library; and
querying the data library to identify the relationship between the first dataset and the second dataset.
